(19) United States
(12) Patent Application Publication
(10) Pub. No.: US 2017/0083856 A1
(43) Pub. Date: Mar. 23, 2017

(54) METHOD AND APPARATUS FOR PROCESSING TRANSMISSION INFORMATION

(71) Applicant: ALIBABA GROUP HOLDING LIMITED, George Town (KY)

(72) Inventor: Yanxue SONG, Hangzhou (CN)

(73) Assignee: ALIBABA GROUP HOLDING LIMITED

(21) Appl. No.: 15/264,310

(22) Filed: Sep. 13, 2016

(30) Foreign Application Priority Data
Sep. 18, 2015 (CN) 201510601030.2

(51) Int. Cl. G06Q 10/08

(52) U.S. Cl. CPC G06Q 10/0832

(57) ABSTRACT

A method for processing transmission information is provided. The method includes pre-storing, a plurality of packaging solutions suitable for use in a plurality of distribution conditions; identifying information from an interaction order upon receiving a request for the transmission information, wherein the identified information includes one or more addresses associated with the interaction order; determining, according to the identified information, whether a cold chain service is needed for a transmission of the interaction order; if the cold chain service is needed, determining a logistics path based on a service coverage and a cold chain function associated with the interaction order and determining a distribution time corresponding to the logistics path; acquiring weather forecast information of the addresses during a distribution period; and determining a packaging solution according to the weather forecast information, the distribution time, and the distribution conditions corresponding to the pre-stored packaging solutions.

### CROSS-REFERENCE TO RELATED APPLICATION

This application is based upon and claims priority to Chinese Patent Application No. 201510601030.2, filed Sep. 18, 2015, the entire contents of which are incorporated herein by reference.

### TECHNICAL FIELD

The present application relates to the field of information processing and, more particularly, to a method and an apparatus for processing transmission information.

### BACKGROUND

Generally, a cold chain service provided by a logistics service provider needs to be used in every link from storage to transmission and distribution for goods in the fresh food category. The cold chain devices that need to be used include a low-temperature cold storage, a normal-temperature cold storage, a low-temperature refrigerator, a regular refrigerator, a refrigerator car, a refrigerated container, a vaccine transport vehicle, a spare ice pack, and the like. Moreover, it is important to choose proper packaging materials (e.g., a carton and a foam box for packaging an item) and fillers (e.g., ice bags during packaging) to make sure that foods are fresh and prevent goods from being damaged.

Conventionally, a warehouse system usually selects a transmission mode in a rough manner according to personal experiences. However, a judgment based on common sense of people is unreliable, and an operation of a warehouse operator is uncontrollable. It often occurs that goods spoil during transportation or materials are wasted due to an inappropriate use of packaging material or filler.

### SUMMARY

The present disclosure provides a method for processing logistics path information. Consistent with some embodiments, the method includes: pre-storing, by a server, a plurality of packaging solutions suitable for use in a plurality of distribution conditions, wherein the distribution conditions each include a weather condition and a distribution time condition; identifying, by the server, information from an interaction order upon receiving a request for the transmission information, wherein the identified information includes one or more addresses associated with the interaction order; determining, according to the identified information, whether a cold chain service is needed for a transmission of the interaction order; if the cold chain service is needed, determining a logistics path based on a service coverage and a cold chain function associated with the interaction order and determining a distribution time corresponding to the logistics path; acquiring, by using a preset network interface, weather forecast information of the addresses during a distribution period; and determining a packaging solution according to the weather forecast information, the distribution time, and the distribution conditions corresponding to the pre-stored packaging solutions.

Consistent with some embodiments, this disclosure provides a method for providing transmission information. The method includes: receiving, by a server, an order generating request from a first client terminal, wherein the order generating request is generated based on an operation of a first user; generating an interaction order and determining a transmission condition of the interaction order; and when the transmission condition of the interaction order is met, sending a transmission instruction to a second client terminal associated with a second user, wherein the second client terminal, in response to receiving the transmission instruction, sends a request for the transmission information to a logistics management server.

Consistent with some embodiments, this disclosure provides a method for requesting transmission information. The method includes: receiving, by a client terminal, a transmission instruction that is sent by a transaction server for an interaction order; and sending, to a logistics management server, a request for the transmission information processing, wherein the logistics management server, in response to receiving the request, identifies information from the interaction order and determines a packaging solution according to the identified information.

Consistent with some embodiments, this disclosure provides a method for performing a transmission process. The method includes: receiving, by a client terminal, a transmission instruction that is sent by a logistics management server for an interaction order, wherein the transmission instruction is generated based on a determination of whether a cold chain service is needed for the interaction order; and identifying a distribution time, weather forecast information, and a packaging solution from the transmission instruction for performing the transmission process.

Consistent with some embodiments, this disclosure provides an apparatus for processing transmission information. The apparatus includes: a storing unit that pre-stores a plurality of packaging solutions suitable for use in a plurality of distribution conditions, wherein the distribution conditions each include a weather condition and a distribution time condition; an information identifying unit that identifies information from an interaction order upon receiving a request for the transmission information, wherein the identified information includes one or more addresses associated with the interaction order; a route information determining unit that determines, according to the identified information, whether a cold chain service is needed for a transmission of the interaction order, and if the cold chain service is needed, determines a logistics path based on a service coverage and a cold chain function associated with the interaction order and determines a distribution time corresponding to the logistics path; a weather information acquiring unit that acquires, by using a preset network interface, weather forecast information of the addresses during a distribution period; and a packaging solution determining unit that determines a packaging solution according to the weather forecast information, the distribution time, and the distribution conditions corresponding to the pre-stored packaging solutions.

Consistent with some embodiments, this disclosure provides an apparatus for providing transmission information. The apparatus includes: a receiving unit that receives an order generating request from a first client terminal, wherein the order generating request is generated based on an operation of a first user; a determining unit that generates an interaction order and determines a transmission condition of the interaction order; and a sending unit that, when the transmission condition of the interaction order is met, sends a transmission instruction to a second client terminal associated with a second user, wherein the second client terminal, in response to receiving the transmission instruction, sends a request for the transmission information to a logistics management server.

Consistent with some embodiments, this disclosure provides an apparatus for requesting transmission information. The apparatus includes: an instruction receiving unit that receives a transmission instruction that is sent by a transaction server for an interaction order; and a request sending unit that sends, to a logistics management server, a request for the transmission information processing, wherein the logistics management server, in response to receiving the request, identifies information from the interaction order and determines a packaging solution according to the identified information.

Consistent with some embodiments, this disclosure provides an apparatus for performing a transmission process. The apparatus includes: a transmission instruction receiving unit that receives a transmission instruction that is sent by a logistics management server for an interaction order, wherein the transmission instruction is generated based on a determination of whether a cold chain service is needed for the interaction order; and an information identifying unit that identifies a distribution time, weather forecast information, and a packaging solution from the transmission instruction for performing the transmission process.

Consistent with some embodiments, this disclosure provides a non-transitory computer readable medium that stores a set of instructions that are executable by at least one processor of a server to cause the server to perform a method for processing transmission information. The method includes: pre-storing a plurality of packaging solutions suitable for use in a plurality of distribution conditions, wherein the distribution conditions each include a weather condition and a distribution time condition; identifying information from an interaction order upon receiving a request for the transmission information, wherein the identified information includes one or more addresses associated with the interaction order; determining, according to the identified information, whether a cold chain service is needed for a transmission of the interaction order; if the cold chain service is needed, determining a logistics path based on a service coverage and a cold chain function associated with the interaction order and determining a distribution time corresponding to the logistics path; acquiring, by using a preset network interface, weather forecast information of the addresses during a distribution period; and determining a packaging solution according to the weather forecast information, the distribution time, and the distribution conditions corresponding to the pre-stored packaging solutions.

Additional objects and advantages of the disclosed embodiments will be set forth in part in the following description, and in part will be apparent from the description, or may be learned by practice of the embodiments. The objects and advantages of the disclosed embodiments may be realized and attained by the elements and combinations set forth in the claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flowchart of an exemplary method for processing transmission information, consistent with some embodiments of this disclosure.

FIG. 2 is a flowchart of an exemplary method for providing transmission information, consistent with some embodiments of this disclosure.

FIG. 3 is a flowchart of an exemplary method for requesting transmission information, consistent with some embodiments of this disclosure.

FIG. 4 is a flowchart of an exemplary method for performing a transmission process, consistent with some embodiments of this disclosure.

FIG. 5 is a block diagram of an exemplary apparatus for processing transmission information, consistent with some embodiments of this disclosure.

FIG. 6 is a block diagram of an exemplary apparatus for providing transmission information, consistent with some embodiments of this disclosure.

FIG. 7 is a block diagram of an exemplary apparatus for requesting transmission information, consistent with some embodiments of this disclosure.

FIG. 8 is a block diagram of an exemplary apparatus for performing a transmission process, consistent with some embodiments of this disclosure.

### DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of devices and methods consistent with aspects related to the invention as recited in the appended claims.

Consistent with some embodiments of this disclosure, multiple packaging solutions and distribution conditions of the packaging solutions, such as a weather condition and a distribution time condition, may be pre-stored. During transmission, a server may recommend a packaging solution according to a specific weather condition and distribution time, and goods need to be packaged according to this packaging solution when they leave the warehouse. In doing so, inaccuracy or mistakes caused by a human-made judgment can be avoided, and distribution quality of commodities can be improved.

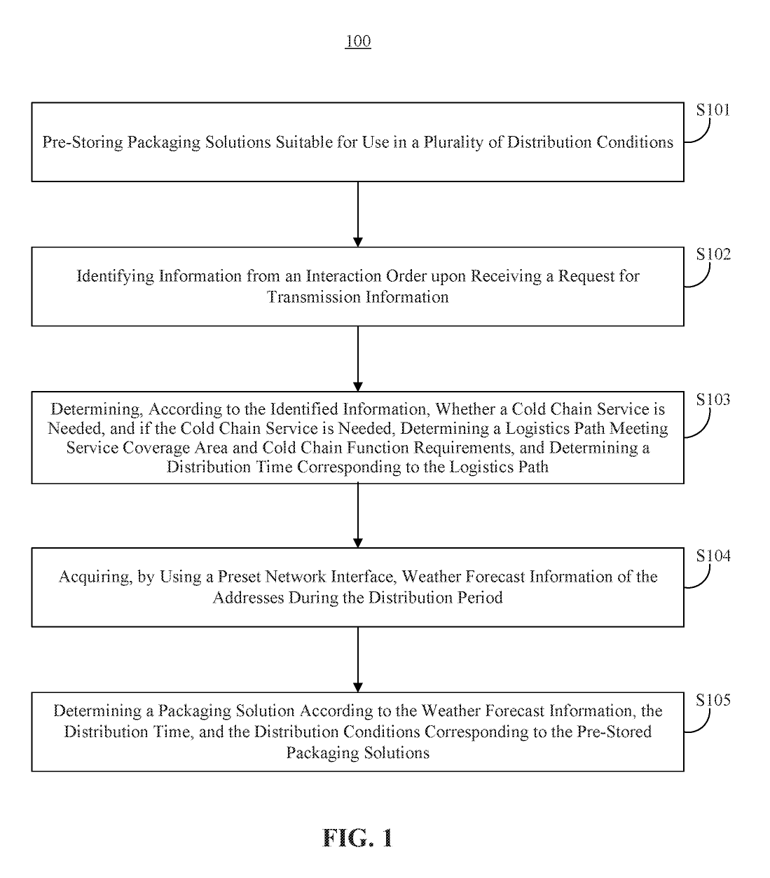

FIG. 1 is a flowchart of an exemplary method 100 for processing transmission information, consistent with some embodiments of this disclosure. The exemplary method 100 may be performed by a server, such as a logistics management server (e.g., a server of CAINIAO, which is a logistics platform of Alibaba Group). Referring to FIG. 1, the method 100 includes the following steps.

In step S101, the server pre-stores a plurality of packaging solutions suitable for use in a plurality of distribution conditions, where the distribution conditions each include a weather condition and a distribution time condition.

In some embodiments, the server may pre-establish various packaging solutions. A packaging solution can be formed by selecting a type of packaging material and a type and quantity of fillers. For example, a packaging solution may be “box of size A+2 ice bags,” meaning that the box of size A is used for packaging and two ice bags are used for filling. As another example, a packaging material and a foam filler may be combined to form a packaging solution, such as “box of size A+foam filler.”

When various packaging solutions are formulated, distribution conditions, such as a weather condition and a distribution time condition, may be set for the packaging solutions. For example, the packaging solution of “box of size A+2 ice bags” may be used when the weather is sunny with a lowest temperature of −10° C. and the distribution time is “arrival in two days.” In some embodiments, the packaging solution may further include means of transportation (such as vehicle or airplane). It should be understood that various packaging solutions that meet distribution conditions can be established according to features of a commodity object. The foregoing example is merely used to exemplarily illustrate this embodiment and does not limit the scope of the present disclosure.

In some implementations, to determine which types of packaging materials, fillers, and quantities of fillers should be used in different weather conditions and distribution time conditions, tests may be carried out by simulating various changes in weather and distribution times, such that delivered goods do not spoil and materials are efficiently used. A corresponding relationship between multiple conditions and packaging solutions may be established. Table 1 below illustrates examples of corresponding relationships between various distribution conditions and packaging solutions.

TABLE 1

| | | Distribution | Packaging | Filler | Filler |
|---|---|---|---|---|---|
| Weather | | time | material type | type | quantity |
| Light | −10° C. | Arrival in | Box of size A, | None | None |
| snow | | one day | (<8° C.) | | |
| Clear | −10° C. | Arrival in | Box of size A, | Ice bag | 4 |
| | | two days | (<8° C.) | | |
| Clear | 31° C. | Arrival in | Box of size B, | Ice bag | 4 |
| | | one day | (<28° C.) | | |
| Heavy | 28° C. | Arrival in | Box of size B+, | Ice bag | 2 |
| rain | | one day | (<28° C., | | |
| | | | rain-proof) | | |
| Light | 33° C. | Arrival in | Box of size C, | Ice bag | 4 |
| rain | | two days | (<35° C., | | |
| | | | rain-proof) | | |
| . . . | . . . | . . . | . . . | . . . | . . . |

In step S102, the server identifies information from an interaction order (i.e., transaction order) upon receiving a request for transmission information (i.e., delivery information). The information may include one or more addresses associated with the interaction order, such as the ship-from address and the ship-to address in the interaction order.

The server may determine whether transmission needs to be arranged for an interaction order in many manners. For example, a user (such as a seller or a business in a transaction platform) may set an automatic transmission label for some particular service types, such that the server may go to an automatic transmission procedure when another user (such as a buyer in the transaction platform) has successfully paid for an interaction order. As another example, a transmission action may be triggered by a client terminal of a user. After receiving a notification message from the transaction platform that a buyer pays for an interaction order successfully, the client terminal may invoke a transmission interface of the server to trigger transmission for the interaction order.

By identifying information from the interaction order, the server may determine a logistics path satisfying a service coverage requirement and determine whether a cold chain service needs to be used.

To determine a logistics path satisfying a service coverage requirement, the information identified from the interaction order may include address information such as a ship-from address (e.g., the origin address) and a ship-to address (e.g., the destination address). The ship-from address may be preconfigured by a user (such as a seller or a business in a transaction platform), and the ship-to address may be set by another user (such as a buyer) when submitting an interaction order. Thus, the server may identify the ship-from address and the ship-to address from the interaction order.

To determine whether a cold chain service needs to be used, the information identified from the interaction order may include identification information of a commodity object, and the server may determine, according to a category to which the commodity object belongs, whether the cold chain service needs to be used. For example, if it is determined that the commodity object belongs to a fresh food category, the server may determine that the cold chain service needs to be used.

In some embodiments, when generating an order, a transaction server may add a preset label to the interaction order of the commodity object involved in the transaction if the commodity object belongs to a particular category. In this way, after the server receives an instruction of arranging transmission for the interaction order, the server may identify information about the label from the transaction and determine, according to the label, whether to use the cold chain service. For example, if a user buys a commodity object of a fresh food category, for example, on the website “miao.tmall.com,” the transaction server may add a “fresh food order” label when generating an interaction order.

In step S103, the server determines, according to the identified information, whether a cold chain service is needed for a transmission of the interaction order, and if the cold chain service is needed, determines a logistics path meeting service coverage and cold chain function requirements, and determines a distribution time corresponding to the logistics path.

Different logistics resources may provide different services. For example, some resources can provide only a warehouse service, and some resources can provide only a distribution service. Among resources that provide distribution services, some resources can provide main line distribution (e.g., distribution to municipal distribution centers only), while some resources can provide landing distribution to deliver the goods to the end customer.

To more fully utilize various logistics resources, in an integrated logistics resource management platform (such as CAINIAO, which is a logistics platform of ALIBABA GROUP) of an e-business system, multiple logistics resources may be combined to form multiple logistics paths. The logistics resources may be classified according to types of services they can provide, such as a transit warehouse, a main line distribution, or a landing distribution. Then, multiple logistics entities may cooperate with each other to provide a logistics service solution, such as using a transit warehouse in conjunction with a main line distribution and a landing distribution, or using a transit warehouse in conjunction with a landing distribution, and so on. The complete logistics service carrier organized by multiple logistics entities and corresponding logistics resources may be referred to as a logistics path. For example, in the logistics service solution using a transit warehouse in conjunction with a main line distribution and a landing distribution, a logistics path in the system is formed by selecting a first logistics service entity capable of providing a transit warehouse service, a second logistics service entity capable of providing a main line service, and a third logistics service entity capable of providing a landing distribution service. The logistics service entities cooperate with each other on each logistics link of commodity distribution so as to provide logistics services.

In practice, there may be an extremely large number of logistics resources, and an extremely large number, usually hundreds of thousands, of logistics paths may be formed by combining different types of logistics resources that have matching service coverage. Thus, various optional logistics paths may be pre-generated, and a business may order logistics paths that meet its own requirements in different scenarios. Alternatively, the logistics resource management platform may perform the assembly of a logistics path when goods are to be shipped. In addition, one logistics resource may have both a transit warehouse function and a landing distribution function, and at this time, one logistics resource can form a logistics path.

In some embodiments, the server may store attribute information of each logistics resource, including a service coverage and a distribution time of the logistics resource, and whether the logistics resource has a cold chain function. For example, if a seller user does not pre-order any logistics path, the server may create a logistics path for the user, and then determine whether each logistics resource on the route has the cold chain function. If each logistics resource on the route has the cold chain function, the logistics path can be used as the logistics path.

One or more logistics paths may be generated according to the address information, such as the ship-from address and the ship-to address in the order, and service coverage information of each logistics resource, where each logistics path includes one or more logistics resources. For example, assuming a ship-from address of an interaction order is Hangzhou and a ship-to address is Beijing, if a logistics path is created by combining a transit warehouse and a landing distribution, transit warehouse providers whose collection coverages include Beijing and landing distribution providers whose distribution coverages include Hangzhou may be acquired. Then a matching operation may be performed on distribution coverages of these transit warehouse providers and collection coverages of these landing distribution providers. If a distribution coverage of a transit warehouse provider successfully matches a collection coverage of a landing distribution provider, the transit warehouse provider and the landing distribution provider can be combined in a logistics path (i.e., a logistics route).

In some embodiments, a user (such as a seller or business in a transaction platform) may order one or more logistics paths according to a category of its commodities, and the server may separately store logistics paths that are ordered by each user. If it is determined that an interaction order needs the cold chain service, the server can determine, according to the pre-stored information, logistics paths associated with the user. The server may filter the logistics paths ordered by the user according to address information associated with the interaction order, and then makes a determination about the cold chain function.

For example, assuming the ship-from address is Beijing and the ship-to address is Shanghai in an interaction order, logistics paths ordered by the seller user include a logistics path 1 consisting of logistics resources WL001 and WL002, and a logistics path 2 consisting of WL001 and WL003. The server may determine, based on the stored attribute information of the logistics resources, that the collection coverage of WL001 includes Beijing, both the distribution area of WL002 and distribution area of WL003 include Shanghai, and both logistics path 1 and logistics path 2 meet the requirement for service coverage.

The server may then determine whether the logistics resources included in logistics path 1 and logistics path 2 have the cold chain function. For example, assuming both WL001 and WL002 have the cold chain function while WL003 does not have the cold chain function, only logistics path 1 meets the cold chain requirement, and logistics path 2 does not meet the cold chain requirement.

In some embodiments, distribution time information of logistics resources may also be pre-stored to determine a distribution time of a logistics path. For example, a logistics path 1 consists of WL001 and WL002, where WL001 is responsible for transport from Beijing to a transit warehouse in Hangzhou, and WL002 is responsible for landing distribution from the transit warehouse in Hangzhou to Shanghai. A distribution time of WL001 from Beijing to Hangzhou is 24 hours, and a distribution time of WL002 from Hangzhou to a specific ship-to address in Shanghai is 24 hours. Accordingly, it can be determined that a distribution time of the logistics path 1 is 48 hours, which is generally referred to as “arrival in two days”.

In some embodiments, if there are multiple logistics paths meeting service coverage and cold chain function requirements, the multiple logistics may be further filtered according to the distribution time, so as to select a final logistics path meeting a preset distribution time (for example, arrival in the shortest time).

In step S104, the server acquires, by using a preset network interface, weather forecast information of the addresses associated with the interaction order during the distribution period.

In some embodiments, cooperation with a weather forecast information provider may be established in advance, so as to acquire an interface of the weather forecast information provider and read weather forecast information in real time. In other embodiments, an information input interface of the server may be provided to the weather forecast information provider, and the weather forecast information provider may enter real-time weather forecast information. For example, if the ship-from address is Beijing, the ship-to address is Shanghai, and the distribution time is 48 hours, weather forecast information of Beijing and Shanghai in 48 hours may be acquired by the server.

In some embodiments, if the goods will stay in a transfer station during transport for a short period of time, the weather condition of the transfer station may also be acquired. For example, assuming the ship-from address is Beijing, and the ship-to address is Shanghai, and the route needs to pass through a transfer station in Hangzhou, weather forecast information of Beijing, Hangzhou, and Shanghai during the distribution period may be acquired. The transfer stations that a logistic route passes through may be preconfigured by the corresponding logistics resource and stored in the server. If the logistics path consists of at least two logistics resources, the transfer station that the route passes through may be determined according to the ship-from address, the ship-to address, and the service coverage of each logistics resource included in the logistics path. For example, if a logistics path 1 consists of WL001 and WL002, where WL001 is responsible for transport from Beijing to a transit warehouse in Hangzhou, and WL002 is responsible for a landing distribution service from the transit warehouse in Hangzhou to Shanghai, it can be determined that the transfer station through which the route passes is Hangzhou.

In step S105, the server determines a packaging solution according to the weather forecast information, the distribution time, and the distribution conditions corresponding to the pre-stored packaging solutions.

After the weather forecast information of the ship-from address and the ship-to address and the distribution time are determined, a matching operation can be performed according to the distribution conditions stored in the server. A packaging solution with a distribution condition that successfully matches the weather forecast information and the distribution time may be a recommended packaging solution.

In some embodiments, since the weather forecast information may involve multiple cities and cover a certain time span, and weather conditions may change at different times and different places, the server may identify changes in weather of related cities in the span of the distribution period, identify weather feature information such as a lowest temperature, a highest temperature, and a weather category, and use such information for performing the matching operation. The weather category may include thunderstorm, snow, hail, and the like, and this information can be used to determine whether a water-proof package needs to be used.

For example, the ship-from address of an interaction order is Beijing, the ship-to address is Shanghai, the transfer station is Hangzhou, the distribution time is 48 hours. The acquired weather forecast of the three cities in 48 hours are as follows.

Beijing: mostly clear in 48 hours, with a highest temperature of 32° C. and a lowest temperature of 25° C.; Hangzhou: mostly cloudy in 48 hours, with thunderstorms weather for a short period of time, a highest temperature of 33° C. and a lowest temperature of 26° C.; Shanghai: mostly light rain in 48 hours, with a highest temperature of 28° C. and a lowest temperature of 20° C.

Based on the above information, the highest temperature of 33° C., the lowest temperature of 20° C., and the weather category “light rain” can be identified. Comparing this information with the conditions in Table 1, it can be seen that the information successfully matches the fifth condition in Table 1, and thus, the packaging solution corresponding to the fifth condition is determined as the packaging solution for transmission, that is, a box of size C (<35° C., rain-proof) is used for packaging and four ice bags are used for filling.

After the packaging solution for transmission is obtained, a transmission instruction may be sent to a client terminal of a warehouse provider, and the packaging solution may be included in the transmission instruction as recommendation information. In this way, the warehouse provider may package and dispatch goods according to the recommended packaging solution, without the need of making a subjective judgment personally, thereby improving the accuracy of a packaging solution determination. In some embodiments, the transmission instruction may also include other information, such as the distribution time, the weather forecast information between the ship-from address and the ship-to address, and so on.

In some implementations, since warehouses may have different processing capabilities, an order deadline may be set for a warehouse in each transaction cycle (for example, one day is set as a transaction cycle). When an interaction order is generated by payment of a buying user later than a particular time point, the server may not deliver the order to the warehouse immediately, but delivers the order to the warehouse after a specified time point. For example, based on the available labor and system processing conditions, a warehouse A in Shanghai may stipulate that orders generated after 16:00 pm are delivered to the warehouse after 7:00 am the next day, and as a result, 16:00 pm is set as the order deadline of the warehouse. Correspondingly, the server may determine information about a transmission warehouse of the interaction order, and determine an order deadline in each transaction cycle set by the transmission warehouse. The server may determine whether the current time is later than the order deadline. If the current time is not later than the order deadline, the server may send the transmission instruction to the client terminal of the transmission warehouse and include the distribution time, the weather forecast information, and information about the packaging solution in the instruction.

In some embodiments, after receiving a packaging complete notification message returned by the client terminal of transmission warehouse, the server may send a distribution instruction to a client terminal of a logistics resource provider for the logistics path and include the distribution time, the weather forecast information, and information about the packaging solution in the instruction. The logistics resource provider may carry out a subsequent logistics service according to the instruction and implement time control based on the information included in the instruction, and take other related protection measures in advance if there is a severe weather feature such as raining.

In the method 100, a server may recommend a packaging solution according to a specific weather condition and distribution time, and goods may be packaged according to this packaging solution when leaving the warehouse. In doing so, inaccuracy or mistakes caused by a human-made judgment may be avoided, and the distribution quality of commodities of a particular category may be improved.

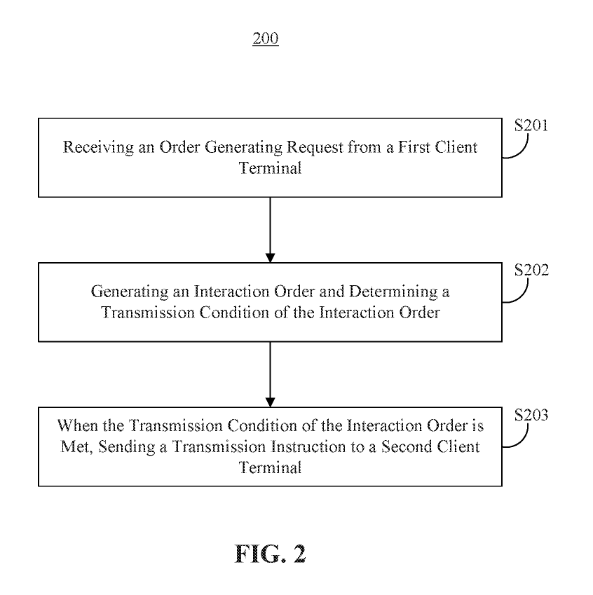

FIG. 2 is a flowchart of an exemplary method 200 for providing transmission information (i.e., delivery information), consistent with some embodiments of this disclosure. The method 200 may be performed by a server, such as a transaction server configured to interact with a front-end user, generate an interaction order, and the like. Referring to FIG. 2, the method 200 includes the following steps.

In step S201, the server receives an order generating request from a first client terminal, where the order generating request is generated based on an operation of a first user.

In step S202, the server generates an interaction order and determines a transmission condition of the interaction order. For example, the interaction order may be a transaction order from a user, and the transmission condition may be a delivery condition for the transaction order.

In step S203, when the transmission condition of the interaction order is met, the server sends a transmission instruction to a second client terminal associated with a second user. The second client terminal may, in response to receiving the transmission instruction, send a request for transmission information to a logistics management server. The logistics management server may then identify information from the interaction order, determine whether a cold chain service is needed according to the identified information, determine a logistics path meeting service coverage and cold chain function requirements if the cold chain service is needed, and determine a distribution time corresponding to the logistics path. The logistics management server may further acquire, by using a preset network interface, weather forecast information of related addresses in the interaction order in the distribution period, and determine a packaging solution according to the weather forecast information, the distribution time, and distribution conditions corresponding to the pre-stored packaging solutions.

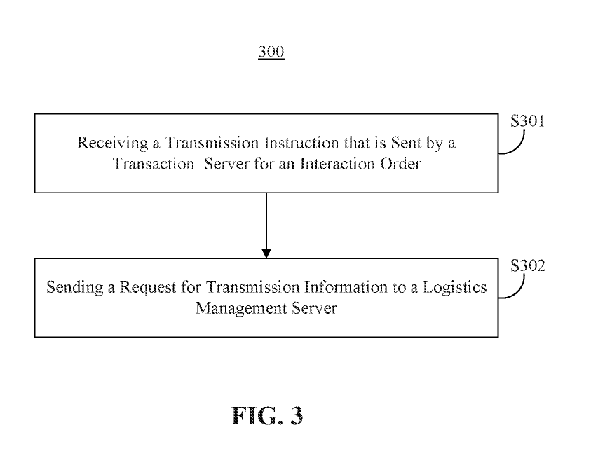

FIG. 3 is a flowchart of an exemplary method 300 for requesting transmission information, consistent with some embodiments of this disclosure. The method 300 may be performed by a client terminal associated with a user (such as a seller, a business, or the like). Referring to FIG. 3, the method 300 includes the following steps.

In step S301, the client terminal receives a transmission instruction that is sent by a transaction server for an interaction order.

In step S302, the client terminal sends a request for transmission information to a logistics management server. In response to receiving the request, the logistics management server may identify information from the interaction order, determine whether a cold chain service is needed according to the identified information, determine a logistics path meeting service coverage and cold chain function requirements if the cold chain service is needed, and determine a distribution time corresponding to the logistics path. The logistics management server may further acquire, by using a preset network interface, weather forecast information of related addresses in the interaction order in the distribution period, and determine a packaging solution according to the weather forecast information, the distribution time, and distribution conditions corresponding to the pre-stored packaging solutions.

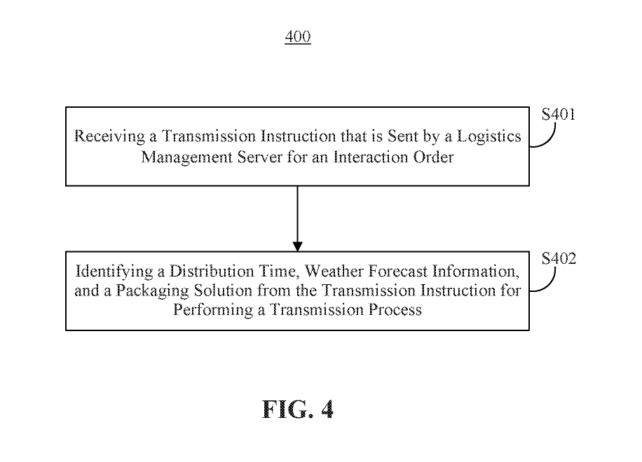

FIG. 4 is a flowchart of an exemplary method 400 for performing a transmission process, consistent with some embodiments of this disclosure. The method 400 may be performed by a client terminal associated with a user (such as a transmission warehouse or the like). Referring to FIG. 4, the method 400 includes the following steps.

In step S401, the client terminal receives a transmission instruction that is sent by a logistics management server for an interaction order. The transmission instruction is generated by the logistics management server based on a determination of whether a cold chain service is needed for the interaction order. For example, when receiving a request for transmission information of the interaction order, the logistics management server determines whether a cold chain service is needed according to information identified from the interaction order. If the cold chain service is needed, the logistics management server determines a logistics path meeting service coverage and cold chain function requirements, and determines a distribution time corresponding to the logistics path. The logistics management server further acquires, by using a preset network interface, weather forecast information of addresses in the interaction order in the distribution period, and determines a packaging solution according to the weather forecast information, the distribution time, and distribution conditions corresponding to the pre-stored packaging solutions.

In step S402, the client terminal identifies a distribution time, weather forecast information, and a packaging solution from the transmission instruction for performing a transmission process.

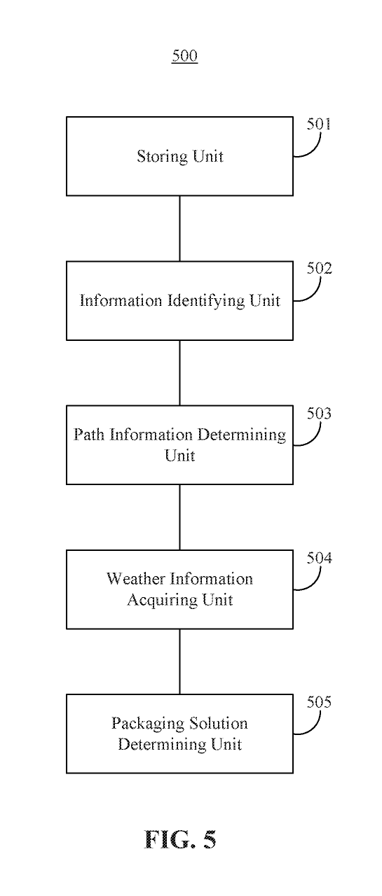

FIG. 5 is a block diagram of an exemplary apparatus 500 for processing transmission information, consistent with some embodiments of this disclosure. The apparatus 500 may be implemented as a part or all of a server, such as a logistics management server. Referring to FIG. 5, the apparatus 500 includes a storing unit 501, an information identifying unit 502, a route information determining unit 503, a weather information acquiring unit 504, and a packaging solution determining unit 505.

The storing unit 501 is configured to pre-store a plurality of packaging solutions suitable for use in a plurality of distribution conditions, where the distribution conditions each include a weather condition and a distribution time condition.

The information identifying unit 502 is configured to identify information from the interaction order upon receiving a request for transmission information, where the identified information includes one or more addresses associated with the interaction order, such as the ship-from address and the ship-to address.

The route information determining unit 503 is configured to determine, according to the identified information, whether a cold chain service is needed, and if the cold chain service is needed, determine a logistics path meeting service coverage and cold chain function requirements, and determine a distribution time corresponding to the logistics path.

The weather information acquiring unit 504 is configured to acquire, by using a preset network interface, weather forecast information of the addresses associated with the interaction order during the distribution period.

The packaging solution determining unit 505 is configured to determine a packaging solution according to the weather forecast information, the distribution time, and the conditions corresponding to the pre-stored packaging solutions.

In some embodiments, the packaging solution determining unit 504 includes a transfer station determining sub-unit, a weather information determining sub-unit, a weather feature identifying sub-unit, and a comparison sub-unit (not shown).

The transfer station determining sub-unit is configured to determine a transfer station through which the logistics path passes according to the logistics path. In some embodiments, the logistics path determined by the route information determining unit 503 includes at least two logistics resources, and the transfer station determining sub-unit is configured to determine the transfer station according to the ship-from address, the ship-to address, and a service coverage of each logistics resource included in the logistics path.

The weather information determining sub-unit is configured to determine weather information of respective geographical areas where the ship-from address, the transfer station, and the ship-to address are located during the distribution period.

The weather feature identifying sub-unit is configured to identify weather feature from the weather information.

The comparison sub-unit is configured to compare the identified weather feature with the distribution conditions corresponding to the pre-stored packaging solutions, and if the identified weather feature matches a distribution condition, determine a packaging solution corresponding to the distribution condition as the packaging solution for transmission.

In some embodiments, the apparatus may 500 further include a transmission warehouse determining unit, an order deadline determining unit, a time determining unit, and a distribution instruction sending unit (not shown).

The transmission warehouse determining unit is configured to determine information about a transmission warehouse of the interaction order.

The order deadline determining unit is configured to determine an order deadline of the transmission warehouse in a transaction circle set by the transmission warehouse.

The time determining unit is configured to determine whether a current time is later than the order deadline, and if the current time is not later than the order deadline, send a transmission instruction to a client terminal of the transmission warehouse. The transmission instruction may include the distribution time, the weather forecast information, and information about the packaging solution.

The distribution instruction sending unit is configured to, after receiving a packaging complete notification message returned by the client terminal of the transmission warehouse, send a distribution instruction to a client terminal of a logistics resource provider for the logistics path, where the distribution instruction includes the distribution time, the weather forecast information, and information about the packaging solution.

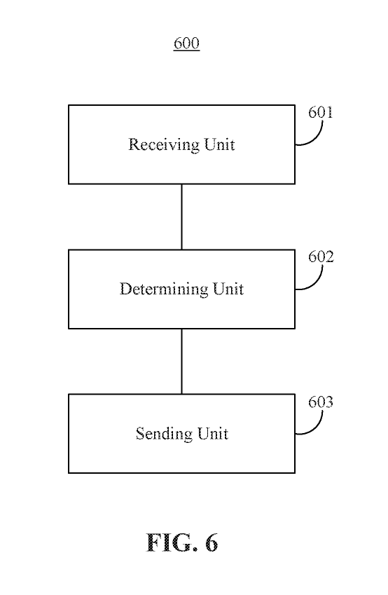

FIG. 6 is a block diagram of an exemplary apparatus 600 for providing transmission information, consistent with some embodiments of this disclosure. The apparatus 600 may be implemented as a part or all of a server, such as a transaction server. Referring to FIG. 6, the apparatus 600 includes a receiving unit 601, a determining unit 602, and a sending unit 603.

The receiving unit 601 is configured to receive an order generating request from a first client terminal, where the order generating request is generated based on an operation of a first user.

The determining unit 602 is configured to generate an interaction order and determine a transmission condition of the interaction order.

The sending unit 603 is configured to, when the transmission condition of the interaction order is met, send a transmission instruction to a second client terminal associated with a second user, so that second client terminal may, in response to receiving the transmission instruction, send a request for transmission information to a logistics management server. The logistics management server may then identify information from the interaction order, determine whether a cold chain service is needed according to the identified information, determine a logistics path meeting service coverage and cold chain function requirements if the cold chain service is needed, and determine a distribution time corresponding to the logistics path. The logistics management server may further acquire, by using a preset network interface, weather forecast information of related addresses in the interaction order in the distribution period, and determine a packaging solution according to the weather forecast information, the distribution time, and distribution conditions corresponding to the pre-stored packaging solutions.

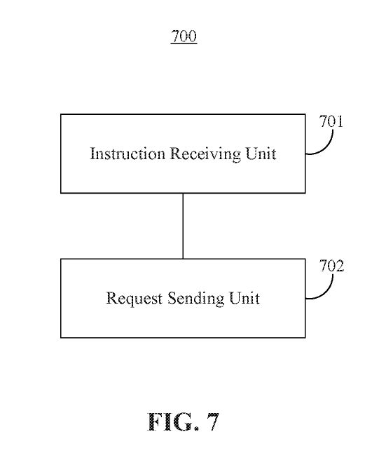

FIG. 7 is a block diagram of an exemplary apparatus 700 for requesting transmission information, consistent with some embodiments of this disclosure. The apparatus 700 may be implemented as a part or all of a client terminal associated with a user (such as a seller, a business, or the like). Referring to FIG. 7, the apparatus 700 includes an instruction receiving unit 701 and a request sending unit 702.

The instruction receiving unit 701 is configured to receive a transmission instruction that is sent by a transaction server for an interaction order.

The request sending unit 702 is configured to send a request for transmission information to a logistics management server. In response to receiving the request, the logistics management server may identify information from the interaction order, determine whether a cold chain service is needed according to the identified information, if the cold chain service is needed, determine a logistics path meeting service coverage and cold chain function requirements, and determine a distribution time corresponding to the logistics path. The logistics management server may further acquire, by using a preset network interface, weather forecast information of related addresses in the interaction order in the distribution period, and determine a packaging solution according to the weather forecast information, the distribution time, and distribution conditions corresponding to the pre-stored packaging solutions.

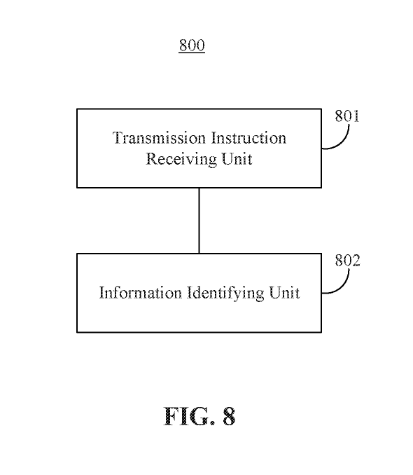

FIG. 8 is a block diagram of an exemplary apparatus 800 for performing a transmission process, consistent with some embodiments of this disclosure. The apparatus 800 may be implemented as a part or all of a client terminal associated with a user (such as a transmission warehouse (i.e., delivery warehouse) or the like). Referring to FIG. 8, the apparatus 800 includes a transmission instruction receiving unit 801 and an information identifying unit 802.

The transmission instruction receiving unit 801 is configured to receive a transmission instruction that is sent by a logistics management server for an interaction order, where the transmission instruction is generated by the logistics management server based on a determination of whether a cold chain service is needed for the interaction order. For example, when receiving a request for transmission information of the interaction order, the logistics management server determines whether a cold chain service is needed according to information identified from the interaction order. If the cold chain service is needed, the logistics management server determines a logistics path meeting service coverage and cold chain function requirements, and determines a distribution time corresponding to the logistics path. The logistics management server further acquires, by using a preset network interface, weather forecast information of addresses in the interaction order in the distribution period, and determines a packaging solution according to the weather forecast information, the distribution time, and distribution conditions corresponding to the pre-stored packaging solutions.

The information identifying unit 802 is configured to identify a distribution time, weather forecast information, and a packaging solution from the transmission instruction for performing a transmission process.

In exemplary embodiments, there is also provided a non-transitory computer-readable storage medium including instructions executable by a processor in a server for performing the above-described methods. For example, the non-transitory computer-readable storage medium may be a ROM, a RAM, a CD-ROM, a magnetic tape, a flash memory, a cache, a register, a floppy disc, an optical data storage device, and the like.

One of ordinary skill in the art will understand that the above described embodiments can be implemented by hardware, software, or a combination of hardware and software. If implemented by software, it may be stored in the above-described computer-readable medium. The software, when executed by the processor can perform the disclosed methods. The computing units and the other functional units described in this disclosure can be implemented by hardware, or software, or a combination of hardware and software for allowing a specialized device to perform the functions described above. One of ordinary skill in the art will also understand that multiple ones of the above described units may be combined as one unit, and each of the above described units may be further divided into a plurality of sub-units.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes may be made without departing from the scope thereof. It is intended that the scope of the invention should only be limited by the appended claims.

What is claimed is:

1. A method for processing transmission information, comprising:
pre-storing, by a server, a plurality of packaging solutions suitable for use in a plurality of distribution conditions, wherein the distribution conditions each include a weather condition and a distribution time condition;
identifying, by the server, information from an interaction order upon receiving a request for the transmission information, wherein the identified information includes one or more addresses associated with the interaction order;
determining, according to the identified information, whether a cold chain service is needed for a transmission of the interaction order;
if the cold chain service is needed, determining a logistics path based on a service coverage and a cold chain function associated with the interaction order and determining a distribution time corresponding to the logistics path;
acquiring, by using a preset network interface, weather forecast information of the addresses during a distribution period; and
determining a packaging solution according to the weather forecast information, the distribution time, and the distribution conditions corresponding to the pre-stored packaging solutions.

2. The method of claim 1, wherein the addresses include a ship-from address and a ship-to address, and wherein determining the packaging solution comprises:
determining a transfer station through which the logistics path passes when distribution is carried out according to the logistics path;
determining weather information of respective geographical areas where the ship-from address, the transfer station, and the ship-to address are located during the distribution period;
identifying a weather feature from the weather information;
comparing the identified weather feature with the distribution conditions corresponding to the pre-stored packaging solutions; and
if the weather feature matches a distribution condition, determining a corresponding packaging solution as the packaging solution.

3. The method of claim 2, wherein the logistics path includes at least two logistics resources, and wherein the transfer station is determined according to the ship-from address, the ship-to address, and a service coverage of each of the at least two logistics resources.

4. The method of claim 1, further comprising:
determining information about a transmission warehouse associated with the interaction order;
determining an order deadline of the transmission warehouse in a transaction cycle;
determining whether a current time is later than the order deadline; and
if the current time is not later than the order deadline, sending a transmission instruction to a client terminal of the transmission warehouse, wherein the transmission instruction includes the distribution time, the weather forecast information, and the packaging solution.

5. The method of claim 4, further comprising:
after receiving a packaging complete notification message returned by the client terminal of the transmission warehouse, sending a distribution instruction to a client terminal of a logistics resource provider in the logistics path, wherein the distribution instruction includes the distribution time, the weather forecast information, and the packaging solution.

6. A method for providing transmission information, comprising:
receiving, by a server, an order generating request from a first client terminal, wherein the order generating request is generated based on an operation of a first user;
generating an interaction order and determining a transmission condition of the interaction order; and
after the transmission condition of the interaction order is met, sending a transmission instruction to a second client terminal associated with a second user, wherein the second client terminal, in response to receiving the transmission instruction, sends a request for the transmission information to a logistics management server.

7. A method for requesting transmission information, comprising:
receiving, by a client terminal, a transmission instruction that is sent by a transaction server for an interaction order; and
sending, to a logistics management server, a request for the transmission information processing, wherein the logistics management server, in response to receiving the request, identifies information from the interaction order and determines a packaging solution according to the identified information.

8. A method for performing a transmission process, comprising:
receiving, by a client terminal, a transmission instruction that is sent by a logistics management server for an interaction order, wherein the transmission instruction is generated based on a determination of whether a cold chain service is needed for the interaction order; and
identifying a distribution time, weather forecast information, and a packaging solution from the transmission instruction for performing the transmission process.

9. An apparatus for processing transmission information, comprising:
a storing unit that pre-stores a plurality of packaging solutions suitable for use in a plurality of distribution conditions, wherein the distribution conditions each include a weather condition and a distribution time condition;
an information identifying unit that identifies information from an interaction order upon receiving a request for the transmission information, wherein the identified information includes one or more addresses associated with the interaction order;
a route information determining unit that determines, according to the identified information, whether a cold chain service is needed for a transmission of the interaction order, and if the cold chain service is needed, determines a logistics path based on a service coverage and a cold chain function associated with the interaction order and determines a distribution time corresponding to the logistics path;
a weather information acquiring unit that acquires, by using a preset network interface, weather forecast information of the addresses during a distribution period; and
a packaging solution determining unit that determines a packaging solution according to the weather forecast information, the distribution time, and the distribution conditions corresponding to the pre-stored packaging solutions.

10. The apparatus of claim 9, wherein the addresses include a ship-from address and a ship-to address, and wherein the packaging solution determining unit comprises:
a transfer station determining sub-unit that determines a transfer station through which the logistics path passes when distribution is carried out according to the logistics path;
a weather information determining sub-unit that determines weather information of respective geographical areas where the ship-from address, the transfer station, and the ship-to address are located during the distribution period;
a weather feature identifying sub-unit that identifies a weather feature from the weather information; and
a comparison sub-unit that compares the identified weather feature with the distribution conditions corresponding to the pre-stored packaging solutions, and if the weather feature matches a distribution condition, determines a corresponding packaging solution as the packaging solution.

11. The apparatus of claim 10, wherein the logistics path includes at least two logistics resources, and wherein the transfer station determining sub-unit is configured to determine the transfer station according to the ship-from address, the ship-to address, and a service coverage of each of the at least two logistics resources.

12. The apparatus of claim 9, further comprising:
a transmission warehouse determining unit that determines information about a transmission warehouse associated with the interaction order;
an order deadline determining unit that determines an order deadline of the transmission warehouse in a transaction cycle;
a time determining unit that determines whether a current time is later than the order deadline, and if the current time is not later than the order deadline, sends a transmission instruction to a client terminal of the transmission warehouse, wherein the transmission instruction includes the distribution time, the weather forecast information, and the packaging solution.

13. The apparatus of claim 12, further comprising:
a distribution instruction sending unit that, after receiving a packaging complete notification message returned by the client terminal of the transmission warehouse, sends a distribution instruction to a client terminal of a logistics resource provider in the logistics path, wherein the distribution instruction includes the distribution time, the weather forecast information, and the packaging solution.

14. An apparatus for providing transmission information, comprising:
a receiving unit that receives an order generating request from a first client terminal, wherein the order generating request is generated based on an operation of a first user;
a determining unit that generates an interaction order and determine a transmission condition of the interaction order; and
a sending unit that, when the transmission condition of the interaction order is met, sends a transmission instruction to a second client terminal associated with a second user, wherein the second client terminal, in response to receiving the transmission instruction, sends a request for the transmission information to a logistics management server.

15. An apparatus for requesting transmission information, comprising:
an instruction receiving unit that receives a transmission instruction that is sent by a transaction server for an interaction order; and
a request sending unit that sends, to a logistics management server, a request for the transmission information processing, wherein the logistics management server, in response to receiving the request, identifies information from the interaction order and determines a packaging solution according to the identified information.

16. An apparatus for performing a transmission process, comprising:
a transmission instruction receiving unit that receives a transmission instruction that is sent by a logistics management server for an interaction order, wherein the transmission instruction is generated based on a determination of whether a cold chain service is needed for the interaction order; and
an information identifying unit that identifies a distribution time, weather forecast information, and a packaging solution from the transmission instruction for performing the transmission process.

17. A non-transitory computer readable medium that stores a set of instructions that is executable by at least one processor of a server to cause the server to perform a method for processing transmission information, the method comprising:
pre-storing a plurality of packaging solutions suitable for use in a plurality of distribution conditions, wherein the distribution conditions each include a weather condition and a distribution time condition;
identifying information from an interaction order upon receiving a request for the transmission information, wherein the identified information includes one or more addresses associated with the interaction order;
determining, according to the identified information, whether a cold chain service is needed for a transmission of the interaction order;
if the cold chain service is needed, determining a logistics path based on a service coverage and a cold chain function associated with the interaction order and determining a distribution time corresponding to the logistics path;
acquiring, by using a preset network interface, weather forecast information of the addresses during a distribution period; and
determining a packaging solution according to the weather forecast information, the distribution time, and the distribution conditions corresponding to the pre-stored packaging solutions.

18. The non-transitory computer readable medium of claim 17, wherein the addresses include a ship-from address and a ship-to address, and wherein the set of instructions that is executable by the at least one processor of the server to cause the server to further perform:
determining a transfer station through which the logistics path passes when distribution is carried out according to the logistics path;
determining weather information of respective geographical areas where the ship-from address, the transfer station, and the ship-to address are located during the distribution period;
identifying a weather feature from the weather information;
comparing the identified weather feature with the distribution conditions corresponding to the pre-stored packaging solutions; and
if the weather feature matches a distribution condition, determining a corresponding packaging solution as the packaging solution.

19. The non-transitory computer readable medium of claim 18, wherein the logistics path includes at least two logistics resources, and wherein the transfer station is determined according to the ship-from address, the ship-to address, and a service coverage of each of the at least two logistics resources.

20. The non-transitory computer readable medium of claim 17, wherein the set of instructions that is executable by the at least one processor of the server to cause the server to further perform:
determining information about a transmission warehouse associated with the interaction order;
determining an order deadline of the transmission warehouse in a transaction cycle;
determining whether a current time is later than the order deadline; and
if the current time is not later than the order deadline, sending a transmission instruction to a client terminal of the transmission warehouse, wherein the transmission instruction includes the distribution time, the weather forecast information, and the packaging solution.
